(19) United States
(12) Patent Application Publication
(10) Pub. No.: US 2009/0041295 A1
(43) Pub. Date: Feb. 12, 2009

(54) Image Display Device, Image Display Method, and Image Display Program

(75) Inventors: Kenji MATSUZAKA, Shiojiri-shi (JP); Ayahiro NAKAJIMA, Matsumoto-shi (JP); Kenji MORI, Matsumoto-shi (JP); Seiji AISO, Shiojiri-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/187,127

(22) Filed: Aug. 6, 2008

(30) Foreign Application Priority Data
Aug. 9, 2007 (JP) 2007-207510

(51) Int. Cl. G06K 9/03

(52) U.S. Cl. 382/100

(57) ABSTRACT

An image display device used for checking an image represented by digital image data includes a display section that displays the image and checking information used for checking the image, an image display control section that displays the image on the display section based on the digital image data, a checking line segment designation section that allows designation of a checking line segment, which is a series of checking places in the image, on the display section on which the image is displayed, and a checking information display control section that displays a changing condition of the digital image data along the checking line segment on the display section as the checking information.

### BACKGROUND

1. Technical Field

The present invention relates to a technology for judging whether or not the image stored as digital data is appropriate.

2. Related Art

Nowadays, images have been becoming easy to handle as digital data. For example, using a digital camera has made it possible to take a photograph of an image quality as high as that of the silver halide photograph with ease and convenience.

Further, handling the image as digital data has also made it possible to check the image on a display screen with ease. For example, in the case in which an image is shot by a digital camera, displaying the shot image on the display screen of the digital camera has made it possible to check the image right after the shooting, thus in the case in which an appropriate image has not been shot, it is also possible to reshoot it immediately. Nonetheless, in the case in which the image is checked on such a display screen, because of the limitation in the size and the resolution of the display screen, a wrong judgment is sometimes made on whether or not the image is appropriate. For example, in the case with the digital camera, there are some cases in which a little failure such as a hand tremor or a blur is neglected because of the low resolution of the display screen thereof, and thus a chance to reshoot the image is missed. In view of such a point, there is proposed a technology for making it possible to more easily judge whether or not the image is appropriate by analyzing the image data with a computer to detect a shooting failure such as a blur or a hand tremor (see e.g., JP-A-2007-128342).

However, the proposed technology has a problem that it is still difficult to appropriately judge whether or not the image is appropriate. For example, in the case with photographic images, since which part of the image the camera is focused on is heavily tinged with the shooter's intention, it is beyond the power of computers to correctly judge whether or not the focus is correct taking the shooter's intention into consideration. In addition, there is also the case in which the shooter varies the focal depth in accordance with the object to be shot, and moreover, there can be the case in which the shooter performs shooting while intentionally making a defocus condition for special effect on picture. Regarding the images thus shot as described above, it is difficult for computers to make an appropriate judgment thereon.

### SUMMARY

An aspect of the invention has an advantage of providing a technology for making it possible to appropriately judge whether or not the image data is appropriate in view of the problem described above.

According to an aspect of the invention, there is provided an image display device used for checking an image represented by digital image data in which the image display device includes a display section that displays the image and checking information used for checking the image, an image display control section that displays the image on the display section based on the digital image data, a checking line segment designation section that allows designation of a checking line segment, which is a series of checking places in the image, on the display section on which the image is displayed, and a checking information display control section that displays a changing condition of the digital image data along the checking line segment on the display section as the checking information.

Further, an image display method of another aspect of the invention corresponding to the image display device described above is an image display method used for checking an image represented by digital image data using an image display device having a display section that displays the image and checking information used for checking the image, the method including the steps of displaying the image on a display section based on a digital image data, allowing designation of a checking line segment, which is a series of checking places in the image, on the display section on which the image is displayed, and displaying a changing condition of the digital image data along the checking line segment on the display section as checking information used for checking the image.

According to the image display device and the image display method of an aspect of the invention, when the image data is loaded and the image is displayed on the display screen, the user determines the part of the image to be checked by designating the line segment on the screen. Here, the line segment to be designated is not limited to a straight line, but can be a curved line. When the user designated the line segment, change in the image data along the line segment is obtained based on the obtained image data on the line segment. On this occasion, it is possible to provide width to the line segment and to obtain the data within the width besides the data on the line segment. After the change in the pixel data along the line segment is thus obtained, the condition of the change is displayed on the display screen so that the user can check it.

According to this process, whether or not the image is appropriate can be judged from the condition in which the image data changes along the line segment. For example, whether or not the image is in-focus, and whether or not the color detail loss is caused can be checked easily from the change in the image data along the line segment, and further, acquiring some experiences also makes it possible to judge whether or not the on-target image can be obtained from the condition in which the image data changes along the line segment. Further, since the change in the image data along the line segment can be displayed in detail on the checking screen, which does not provide an enough size, judgment for the detailed section is also possible. In addition, since the user can freely designate the line segment for checking, it becomes possible for the user to draw the line segment along the intention when the image is shot and to examine the condition of the image data, thus it becomes possible to appropriately judge whether or not the image is appropriate along the intention when the image was shot.

Further, in the image display device of a further aspect of the invention, the designation of the checking line segment can be performed by the user designating a plurality of points on the screen. For example, it is possible to designate a plurality of points on the screen, and interpolate the points with a straight line or a curved line, thereby designating the checking line segment; Alternatively, it is also possible to continuously designate the plurality of points by tracing the surface of the screen, and the line segment linking the plurality of points is used as the checking line segment.

According to this process, since the user can easily designate the checking line segment as intended, it becomes possible to appropriately designate the part to be checked, and as a result, it becomes possible to more appropriately judge whether or not the image is appropriate. In particular, in the image shooting equipment such as a digital camera, since the operation section is designed for giving priority to easiness of shooting or checking of the images, the operation of designating the line segment on the checking screen is not necessarily easy. Therefore, if the checking line segment can be designated only by designating a plurality of places on the checking screen, the designation becomes extremely simple, which is preferable.

Further, it is also possible that a plurality of line segment is previously set, and the user selects the desired line segment in the plurality of line segments, thereby designating the checking line segment. In this case, the line segments set previously can be set independently of the image data, or set in the area where the object is shown up after the image data is analyzed to extract the object.

According to this process, since the user is only required to select the desired line segment from the candidate line segments, it becomes possible to designate the part to be checked with extreme ease and convenience. Although there is a possibility that the setting freedom is decreased to some extent in comparison with the case in which the user sets the line segment, the practical down side can be eliminated by previously setting a large number of selectable line segments as the candidates, instead, it becomes possible to obtain the significant advantage that the checking line segment can extremely easily be designated even with a poor operation section.

Further, in the image display device of a further embodiment, it is also possible to obtain the change in the luminance value along the designated line segment.

Since the luminance value is a fundamental parameter of the image, in general, the feature of the image tends to be reflected on the luminance value, and further, it is easy for the user to sensuously understand the change in the luminance value. For such a reason, obtaining the change in the luminance value along the checking line segment and displaying it on the display screen make it possible for the user to easily judge whether or not the image is appropriate. Further, since the luminance value, which is the fundamental parameter, can easily be obtained from the image data, there is preferably no need for increasing the process load for obtaining the data.

Further, in the image display device of a further embodiment, it is possible to obtain the change along the checking line segment in the tone value of each component forming the image data. For example, if the image data is so-called RGB image data, it is also possible to display the change in the tone value of the component regarding the respective components of R, G, and B (or either one of these components). On this occasion, it is also possible to display the respective components forming the image data not directly, but after converting the tone values of the components into the components forming the image data with an other format. For example, it is also possible to convert the tone values of the respective components of R, G, and B into the tone values of hue (H component), saturation (S component), and brightness (B component), and to display at least one component thereof.

For example, in the case in which the part, which is different only in the hue and the same in other components including brightness, is included in the image, when it is attempted to check whether or not the appropriate image is obtained in that part, the judgment is not executable by displaying the change in the luminance, but can be executable if the change in the component forming the image data is detected. As described above, displaying the change in the component forming the image data makes it possible to check whether or not the appropriate image has been obtained in more cases.

Further, in the image display device of a further aspect of the invention, it is also possible to execute a correction process on the loaded image data. Further, it is also possible to obtain the data from the corrected image data along the checking line segment, and to display the change in the data along the line segment on the screen.

As described above, whether or not the image is appropriate can be more appropriately checked by checking the change in the image data along the checking line segment than by checking the image displayed on the checking screen. Therefore, in the case of executing a correction on the image data, it becomes possible to more appropriately check whether or not the correction is appropriate or not by checking the change in the corrected image data along the checking line segment than by displaying the corrected image on the checking screen.

Further, a further aspect of the invention can be realized making a computer load the computer-readable medium for realizing the image display method described above to perform predetermined functions. Therefore, the invention includes an aspect as the computer-readable medium described below. Specifically, the computer-readable medium of an aspect of the invention corresponding to the image display method described above is an image display computer-readable medium for allowing a computer to execute a process used for checking the image, having a display section that displays an image represented by digital image data and checking information used for checking the image to the process including displaying the image on a display section based on a digital image data, allowing designation of a checking line segment, which is a series of checking places in the image, on the display section on which the image is displayed, and displaying a changing condition of the digital image data along the checking line segment on the display section as checking information used for checking the image.

By making the computer load the computer-readable medium to realize the functions described above, it becomes possible to appropriately judge whether or not the digital image data is appropriate.

### BRIEF DESCRIPTION OF THE DRAWINGS

The invention will now be described with reference to the accompanying drawings, wherein like numbers references like elements.

FIG. 1 is an explanatory diagram showing a configuration of a digital camera of the present embodiment of the invention.

FIG. 2 is an explanatory diagram showing the condition in which an image is displayed on a monitor screen.

FIG. 3 is a flowchart showing flow of an image checking process of the present embodiment.

FIG. 4 is an explanatory diagram showing the condition in which a shooter is drawing a line on the monitor screen.

FIG. 5 is an explanatory diagram showing the condition in which a graph of luminance value is displayed on the monitor screen.

FIGS. 6A through 6C are explanatory diagrams showing the condition in which focus is checked with the graph of the luminance value.

FIG. 7 is an explanatory diagram showing the condition in which a sample graph is displayed together with the graph of the luminance value.

FIG. 8 is an explanatory diagram showing the condition in which whether or not the highlight detail loss is caused in the image is checked.

FIG. 9 is an explanatory diagram showing the condition in which a graph of RGB tone values is displayed on the monitor screen in a first modified example.

FIG. 10 is an explanatory diagram showing the condition in which a graph of tone values of RAW data is displayed on the monitor screen in a second modified example.

FIGS. 11A through 11C are diagrams showing the conditions in which the change in the luminance value after correction is checked while sharpness correction is being executed in a third modified example.

FIGS. 12A through 12C are diagrams showing the conditions in which RGB tone values are checked while white balance adjustment is being executed in a fourth modified example.

### DESCRIPTION OF EXEMPLARY EMBODIMENTS

In the description provided below, an embodiment of the invention will be explained along the following order in order for clarifying an content of the invention described above.

A. Device Configuration

B. Image Confirmation Process

C. Modified Examples
C-1. First Modified Example
C-2. Second Modified Example
C-3. Third Modified Example
C-4. Fourth Modified Example

### A. DEVICE CONFIGURATION

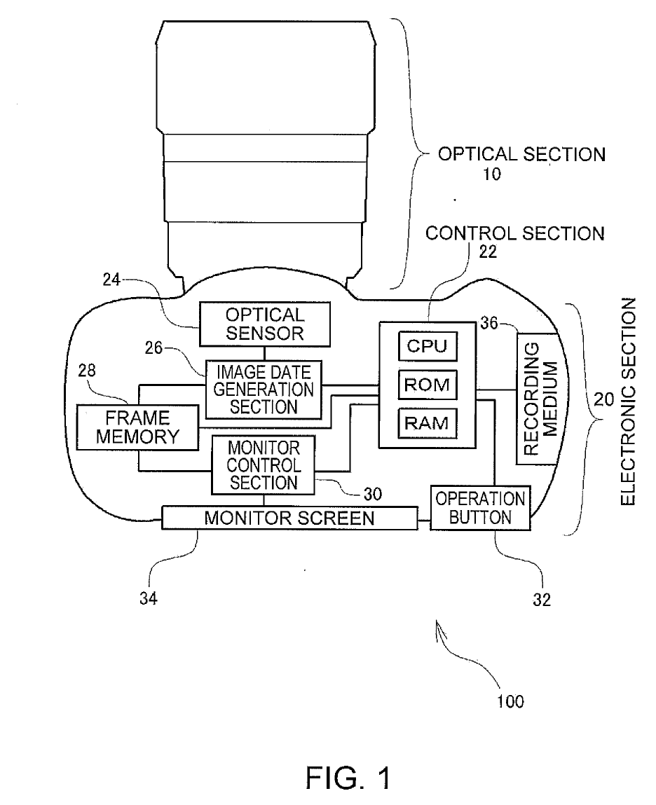

FIG. 1 is an explanatory diagram showing a device configuration of a digital camera 100 equipped with an image display device of the present embodiment of the invention. As shown in the drawing, the digital camera 100 is composed of an optical section 10 for imaging the light from the shooting object, and an electronic section 20 for recording the image imaged by the optical section 10 as digital data. The optical section 10 is composed of various kinds of optical components such as an optical lens, an optical filter, and an aperture section, and is arranged to allow the shooter to zoom in the object, vary the light intensity to adjust the luminance of the image, vary the aperture thereby adjusting the area (the depth of field) on which the camera is focused, and so on by operating the optical section 10.

Around a control section 22 having a CPU the electronic section 20 is composed of various electronic devices such as an optical sensor 24 and an image data generation section 26 both for converting the image into digital data, a frame memory 28 for temporally recording the image data thus generated, and a monitor screen 34 for displaying the shot image. Each of these devices is connected to the control section 22, and the control section 22 undertakes a role of controlling the entire digital camera 100 by controlling each of the devices. Further, the control section 22 is provided with operation buttons 32 connected thereto, so that the shooter can operate the digital camera 100 by sending instructions to the control section 22 via the operation buttons 32.

The digital camera 100 having such a configuration shoots the object as the digital data in a following manner. Firstly, when the light from the object enters the optical section 10, the light is imaged on the optical sensor 24 by the optical section 10. The optical sensor 24 has the structure paved with a number of semiconductor elements in a plane, and each of the semiconductor elements converts the imaged light into an electrical charge by the photoelectric effect. Since the amount of electrical charge converted into by the photoelectric effect is in proportion to the light intensity, the amount of electrical charge in the semiconductor element of the part of the optical sensor 24 with high light intensity becomes large, and on the contrary, the amount of electrical charge in the semiconductor element of the part thereof with low light intensity becomes small. As a result, an electrical charge distribution corresponding to the image is formed on the optical sensor 24.

After the electrical charge distribution is formed on the optical sensor 24, the image data generation section 26 reads out the electrical charge on the optical sensor 24 as an electrical current, thereby obtaining an analog signal corresponding to the image. Subsequently, by executing A/D conversion in the analog signal thus obtained, the digital data (the image data) corresponding to the image is obtained. After the image data is thus obtained, the obtained image data is transmitted to the frame memory 28 so that the image data can also be used by the control section 22 and a monitor control section 30. After the image data is thus obtained on the frame memory 28, operating the operation buttons 32 makes it possible for the shooter to record the image data on a recording medium 36 or to display the image data on the monitor screen 34 to check the image.

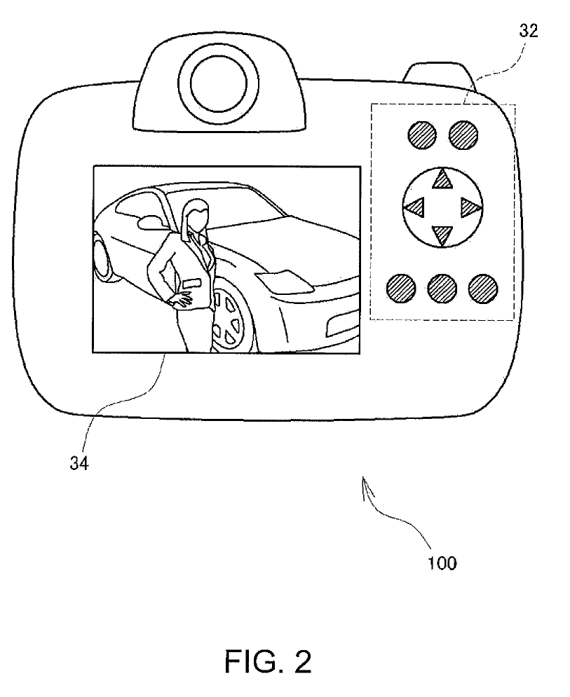

FIG. 2 is an explanatory diagram exemplifying the condition in which the shot image is displayed on the monitor screen 34. Since the shooter can check whether or not the image is appropriately shot when looking at the monitor screen 34, if the image is not appropriately shot with a blur or a hand tremor, it is also possible to reshoot the image immediately. Nonetheless, since the monitor screen 34 has a small screen size and low resolution, the blur and the hand tremor caused on the monitor screen 34 are neglected in most cases. Therefore, in the digital camera 100 of the present embodiment, “an image checking process” described below makes it possible to appropriately judge whether or not the image is appropriate.

### B. IMAGE CONFIRMATION PROCESS

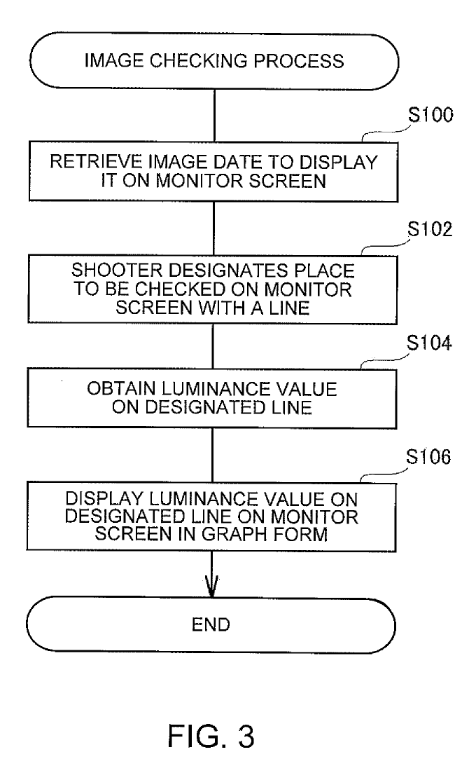

FIG. 3 is a flowchart showing flow of the image checking process of the present embodiment. The process is executed by the CPU of the control section 22 in response to the shooter operating the operation buttons 32. As shown in the drawing, when the process is started, firstly the process for retrieving the image data to be displayed on the monitor screen 34 is executed (step S100). Since the image data is recorded on the frame memory 28, the control section 22 provides the monitor control section 30 with the instruction of retrieving the image data from the frame memory 28, and in response thereto, the monitor control section 30 retrieves the image data and displays the image on the monitor screen 34.

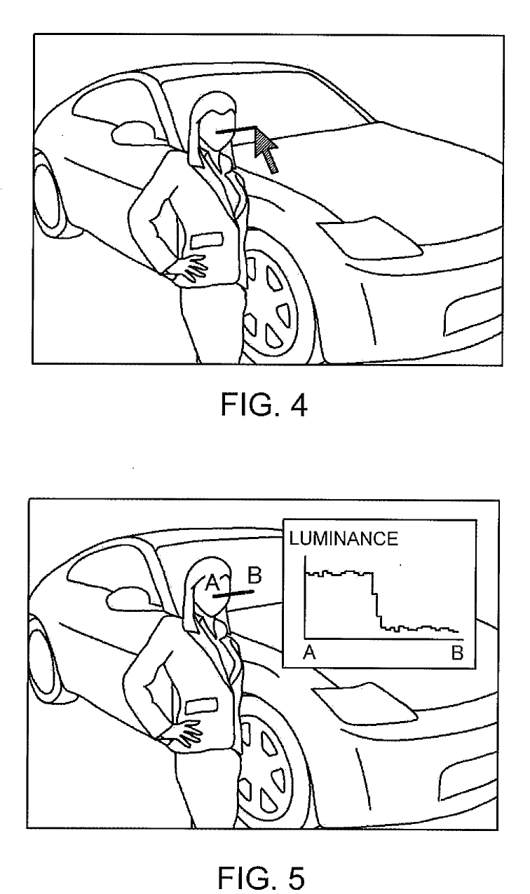

After the image is displayed on the monitor screen 34, the process that the shooter designates the part of the image to be checked is subsequently executed (step S102) Specifically, as shown in FIG. 4, since the CPU of the control section 22 displays a cursor arrow on the monitor screen 34, the shooter operates the cursor arrow by the operation buttons 32 to draw a line in the part of the image to be checked. Although explaining later in detail, since it becomes possible in the image checking process of the present embodiment to check the image data in detail along the line drawn by the shooter, it is enough for the shooter to draw a line in the part the shooter would like to check in the image. For example, in the example shown in FIG. 4, in order for checking whether or not the contour of the face of the figure is shot with appropriate focus, the line is drawn so as to traverse the contour of the face.

After the shooter draws the line in the part expected to be checked, the control section 22 retrieves the data of the pixels in the part where the line is drawn form the frame memory 28, and obtains the luminance value of each of the pixels (step S104 in FIG. 3). There could be a variety of forms of data such as the YCC data or the RGB data as the pixel data, and any form of data can be adopted here. For example, in the case with the YCC data, it is possible to obtain the Y tone value directly as the luminance value, or in the case with the RGB data, it is possible to obtain the luminance value from the tone values of R, G, and B along the conversion formula. After thus obtaining the luminance values of the pixels in the part provided with the line, the luminance values thus obtained are displayed on the monitor screen 34 in graph form (step S106).

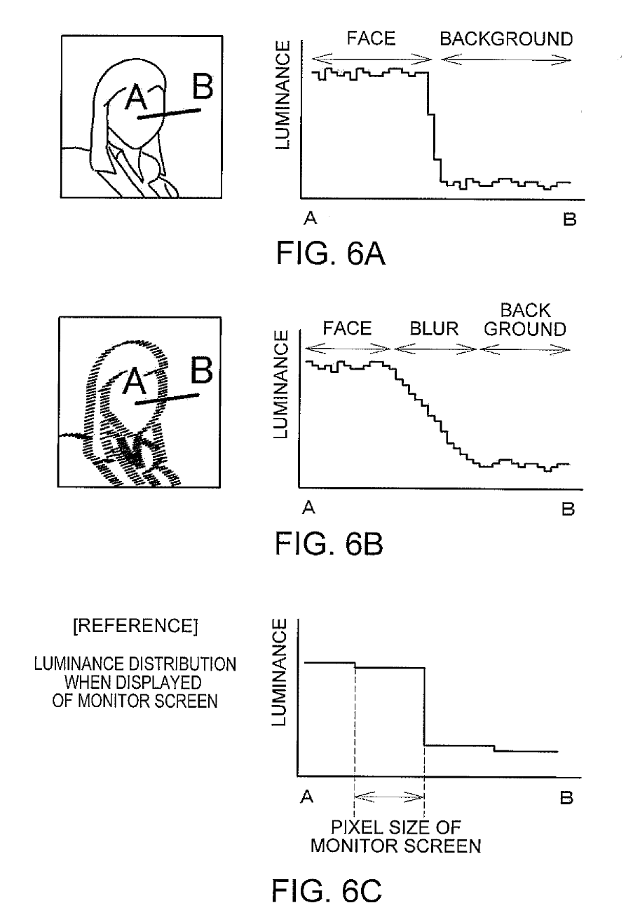

FIG. 5 is an explanatory diagram exemplifying the condition in which the graph of the luminance value is displayed on the monitor screen 34. The horizontal axis of the graph represents the position on the line (the line segment A-B in FIG. 5) drawn by the shooter, and the vertical axis thereof represents the luminance values at respective positions. According to the graph, how the luminance value varies along the line drawn by the shooter can be understood. Further, it becomes possible for the shooter to easily judge whether or not the focus is appropriate from how the luminance value varies. This point will be explained below with reference to FIGS. 6A through 6C.

FIGS. 6A through 6C are explanatory diagrams exemplifying the condition in which whether or not the focus is appropriate is judged based on the variation in the luminance value. FIG. 6A shows the image shot in the in-focus condition, and FIG. 6B shows the image shot in the out-of-focus condition, on the other hand. In the case with the in-focus image (see FIG. 6A), since the contour of the face of the figure is shown up clearly, the boundary between the face section and the background section is clear. In accordance therewith, also in the graph of the luminance value, the luminance value has a rapid change at the transition from the face section to the background section. In contrast, in the case with the out-of-focus image (see FIG. 6B), since the blur is caused in the contour of the face, the boundary between the face section and the background section becomes unclear, and as a result, also in the graph of the luminance value, the boundary between the face section and the background section is unclear, thus the luminance value changes gradually from the face section to the background section. As described above, since the luminance value has a rapid change at the contour section if the image is in-focus, or the luminance value changes gradually in the contour section if the image is out-of-focus on the contrary, it becomes possible for the shooter to easily judge whether or not the focus is appropriate when looking at the graph of the luminance value variation.

After thus displaying the graph of the luminance value, the CPU of the control section 22 terminates the image checking process shown in FIG. 3. Thus, when it is checked from the graph of the luminance value that shooting has been performed with appropriate focus, the shooter can operate the operation buttons 32 to record the image data on the recording medium 36, or in the case with the out-of-focus image, it is possible to reshooting the image without recording it on the recording medium 36.

It should be noted that although what the shooter draws the line segment A-B on for displaying the variation in luminance value is the monitor screen 34 (see FIG. 4), the graph of the luminance variation displayed in response thereto is not for the luminance values of the image data on the monitor screen 34 but for the luminance values of the original image data. This is because, when the image is displayed on the monitor screen 34, the pixel becomes coarser than in the original image data because of the limited resolution of the monitor screen 34 (see FIG. 6C). Therefore, even if a blur is caused in the contour of the face in the original image data, when viewing the image on the monitor screen 34, the blurred part is buried in the coarseness of the pixel, and the image is viewed as if it is the in-focus image. For this reason, it is difficult to recognize that the image is out-of-focus only by looking at the luminance variation in the image data on the monitor screen 34. In contrast, since it can be recognized at a glance that the luminance value changes gradually as shown in FIG. 6B by displaying the variation in the luminance value of the original image data in graph form, the out-of-focus image can easily be recognized. For such a reason, in the digital camera 100 of the present embodiment, although the line segment A-B for displaying the variation in the luminance value is designated on the monitor screen, the variation in the luminance value regarding the original image data is displayed as the actually displayed variation in luminance value. As a result, it can be eliminated that a blur is neglected to miss a chance to reshoot the image, thus it becomes possible for the shooter to immediately reshoot the image if there are any blurs.

Further, in the image checking process of the present embodiment, since the part to be checked can be designated by the shooter, it becomes possible to appropriately judge whether or not the focus is appropriate along the intention when shooting the image. For example, in the image shown in FIG. 4, there is shot the condition in which a figure stands in front of a car, and whether focusing on the figure is important or focusing on the car is important in the image varies depending on the intention of the shooter regarding what the shooter placed importance on in shooting the image. In such a case, since there is no chance to know the intention of the shooter by a commonly used focus judgment method in which the focus is judged based on the object obtained by analyzing the image data, in some cases, the focus on the car is examined even though the image is shot placing importance on the figure, or contrary, the focus on the figure is examined even though the image is shot placing importance on the car. In contrast, according to the image checking process of the present embodiment, the focus is examined in the figure section if the image is shot placing importance on the figure, and if the image is shot placing importance on the car, the focus is examined in the car section, thus it becomes possible for the shooter to appropriately judge whether or not the focus is appropriate along his or her own intention.

Further, there is also the case in which not only which part the camera is focused on, but also how accurately the focus is adjusted varies depending on the intention of the shooter For example, there can be the case in which the shooting is performed with the intention to exert the effect of providing the image with softness by applying a slight blur to the image, or the case in which the shooting is performed for the effect of drawing viewer's attention to a small portion of the image by intensively focusing the camera on the small portion with the reduced depth of field In such cases, since no one knows how accurately the focus has been intend to be adjusted when the shooting has been performed except the shooter, there is no chance to judge whether or not the focus has been appropriate along the intention of the shooter by the commonly used focus judgment method executed by analyzing the image data. In contrast, in the image checking process of the present embodiment, since the shooter can understand how accurately the focus is adjusted from the blur section (see FIG. 6B) of the graph of the luminance value, it becomes possible for the shooter to appropriately judge whether or not the shooting is performed with the focus intended by the shooter.

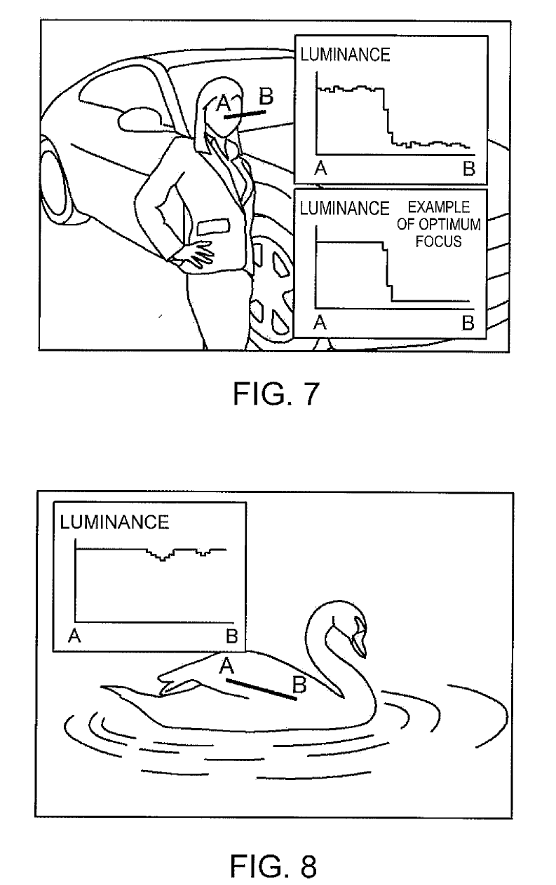

It should be noted that when the graph of the luminance value is displayed, it is also possible to display a sample graph in parallel to the graph of the luminance value so that the shooter can easily judge whether or not the focus is appropriate. FIG. 7 shows the condition in which such a sample graph is displayed. The sample graph can be previously prepared in a ROM of the digital camera 100, or can be stored in the digital camera 100 by the shooter when the image with the favorite focus has been shot. By displaying such a sample graph together therewith, since the two graphs can visually be compared, it becomes possible for the shooter to more easily judge whether or not the shooting is performed with desired focus.

Further, in the image checking process of the present embodiment, since the not only the contour section of the object but also any areas can be designated, not only the focus but also various targets can be checked. For example, as shown in FIG. 8, by checking the luminance value in the body section of the swan, whether or not a so-called highlight detail loss phenomenon is caused can also be checked. In the case in which the white object such as a swan is shot, a phenomenon (the highlight detail loss) that the luminance value is kept at the upper limit value is apt to occur, and in such a case, since the delicate difference in white is difficult to be recognized on the monitor screen, it is difficult to judge whether or not the highlight detail loss is caused by only looking at the image on the monitor screen. Therefore, when the white part as shown in FIG. 8 is designated, it becomes possible to check whether or not the highlight detail loss has occurred because the graph of the luminance value at that part can be seen.

It should be noted that when designating the part to be checked on the image (see S102 in FIG. 3), it is also possible to draw a curved line instead of a straight line. Thus, since the shooter can draw a line as he or she intends, the area to be checked can more appropriately be designated. Further, it is also possible that the monitor screen 34 is formed as a touch-panel screen so that such a line can more easily be drawn, and the monitor screen is directly traced with a stylus or the like. Alternatively, it is also possible to make the shooter designate a plurality of points, and interpolate the points with a straight line or a curved line, thereby determining the part to be checked. According to this process, since it is enough for the shooter to designate the points, the shooter can more easily designate the part to be checked.

Still further, it is also possible that a plurality of candidate straight lines (or curved lines) is previously offered to the shooter, and then the shooter selects the appropriate line from the candidate lines. For example, it is also possible that a plurality of candidate lines is set previously independently of the image, and in the case in which the shooter checks the image, the candidate lines are displayed in the condition in which the image is displayed on the monitor screen 34 so as to overlap the image, thus the shooter selects the desired line therefrom. Alternatively, it is also possible that the image data is analyzed to extract the object, and the candidate line segments are displayed in the area where the object is shown up so as to overlap the object. According to this process, since it is only required to select an appropriate one from the offered candidate lines, it becomes possible for the shooter to easily and conveniently check the image without performing cumbersome operations.

Further, it is also possible that when obtaining the data of the pixels along such a line (see S104 in FIG. 3), the data of not only the pixels on the line but also the pixels adjacent to the pixels on the line are obtained. According to this process, even if noise is added on the data of the pixels on the line, the influence of the noise can be reduced by using the average luminance value between the pixels on the line and the pixels adjacent thereto. Further, since there is no chance to be misled by the noise by using the luminance values thus obtained, it becomes possible for the shooter to appropriately judge whether or not the image is appropriate from the graph of the luminance value.

### C. MODIFIED EXAMPLES

### C-1. First Modified Example

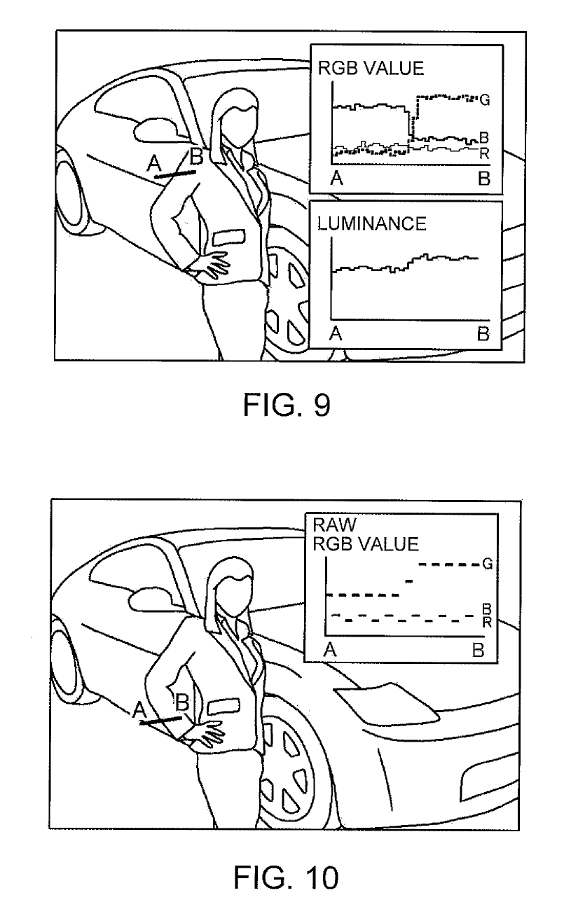

In the embodiment described above, the explanation is presented assuming that whether or not the image is appropriate is checked by displaying the graph of the luminance value. However, it is also possible to display not only the graph of the luminance value, but also the RGB values or the HSB values in graph form. FIG. 9 is an explanatory diagram exemplifying the condition in which the graph of the RGB values is displayed. By thus displaying the graph of the RGB values, it is possible to appropriately check the focus even in the case in which it is difficult to check the focus from the change in the luminance value. For example, in the example shown in FIG. 9, the body section (the point A in the drawing) of the vehicle and the clothes section (the point B in the drawing) of the figure have roughly the same luminance values although the colors thereof are different, and therefore, the change in the luminance value at the boundary is too small to easily check whether or not the image is in-focus from the graph of the luminance value (see the lower graph in FIG. 9). Even in such a case, displaying the graph of the RGB values makes it possible to judge whether or not the focus is appropriate from this graph, because the RGB values change at the boundary because the colors of the clothes section and the body section are different from each other (see the upper graph in FIG. 9).

### C-2. Second Modified Example

Further, it is also possible to directly display the tone values of so-called RAW data in graph form instead of the RGB values. Here, the RAW data denotes the data directly digitized the light intensity detected by the semiconductor elements on the optical sensor 24. Since the semiconductor elements corresponding respectively to the colors of R, G, and B are sequentially arranged on the optical sensor 24, in the RAW data, one pixel (corresponding to one semiconductor element) only have the tone value of either one of the R, G, and B unlike the normal RGB image data in which one pixel has three tone values of R, G, and B. FIG. 10 shows the condition in which such RAW data is displayed in graph form. Since in the RAW data, one pixel only have the tone value of either one of the R, G, and B, as shown in the drawing, the graph of the tone values becomes a noncontiguous graph. However, since the condition in which the tone value changes at the contour section of the object can be recognized even by such a graph, thus whether or not the focus is appropriate can be checked. As described above, since the focus can be checked by directly displaying the RAW data in graph form without executing the process (RAW development process) of generating the RGB image data from the RAW data, it becomes also possible to ease the processing load of the image data generation section 26 in charge of the RAW development process.

### C-3. Third Modified Example

In the embodiment and the modified example described above, the explanation is presented assuming that whether of not the shooting has been performed appropriately is checked by displaying the graph of the luminance value of the image. However, it is also possible to check not only whether or not the shooting has been appropriate, but also whether or not a correction process has been appropriate by displaying the graph of the luminance value after the correction process has been executed thereon.

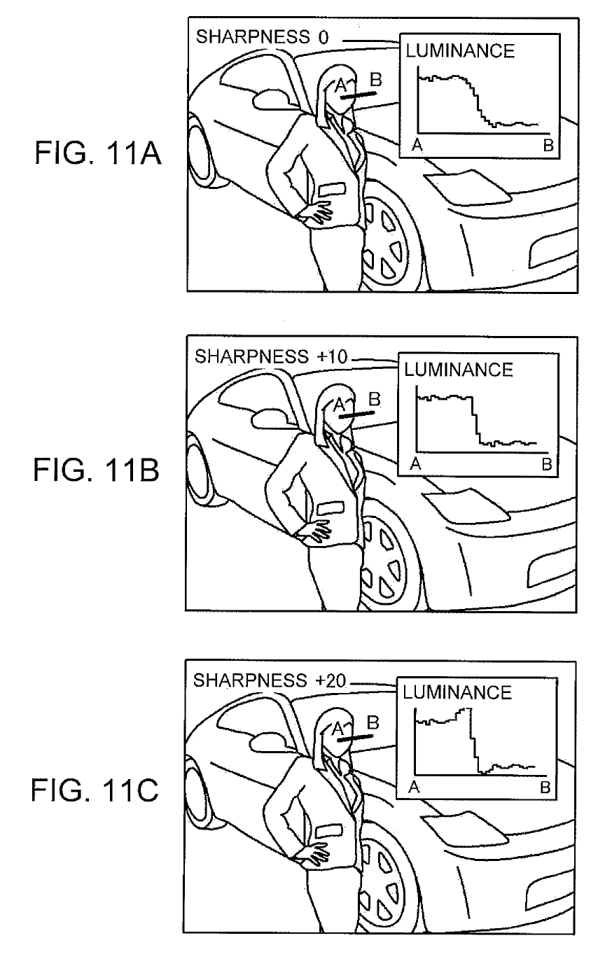

FIGS. 11A through 11C are explanatory diagrams exemplifying the condition in which the luminance value is checked while the sharpness correction on the image is being executed. FIG. 11A shows the original image on which no sharpness correction is executed, FIG. 11B shows the image on which the sharpness correction is executed, and FIG. 11C shows the image on which the sharpness correction is executed more strongly than in the case shown in FIG. 11B. The sharpness correction is executed by providing a so-called unsharpness mask such as a Laplacian filter to the image data, and in such a correction, the image data is corrected so that the luminance value is rapidly changed at the contour section by the correction increasing or decreasing the luminance value in the contour section. For example, in the graph shown in FIG. 11B in which the sharpness correction is executed, the luminance value is changed more rapidly at the contour section in comparison to the graph of the original luminance value shown in FIG. 11A. Thus, there is exerted the effect of making the blur in the contour section of the object less noticeable to make the outline be viewed clearly. However, if the correction is executed thereon too strongly, the luminance value in the contour section becomes higher than the luminance value in the surrounding area as shown in the graph of FIG. 11C resulting in an artificial image with the contour section strangely emphasized. Therefore, by displaying the graph of the corrected luminance value as shown in FIGS. 11A through 11C, the luminance value after the correction can be checked so that the strength of the correction can be adjusted, thus it becomes possible to execute the appropriate correction without applying too much correction.

### C-4. Fourth Modified Example

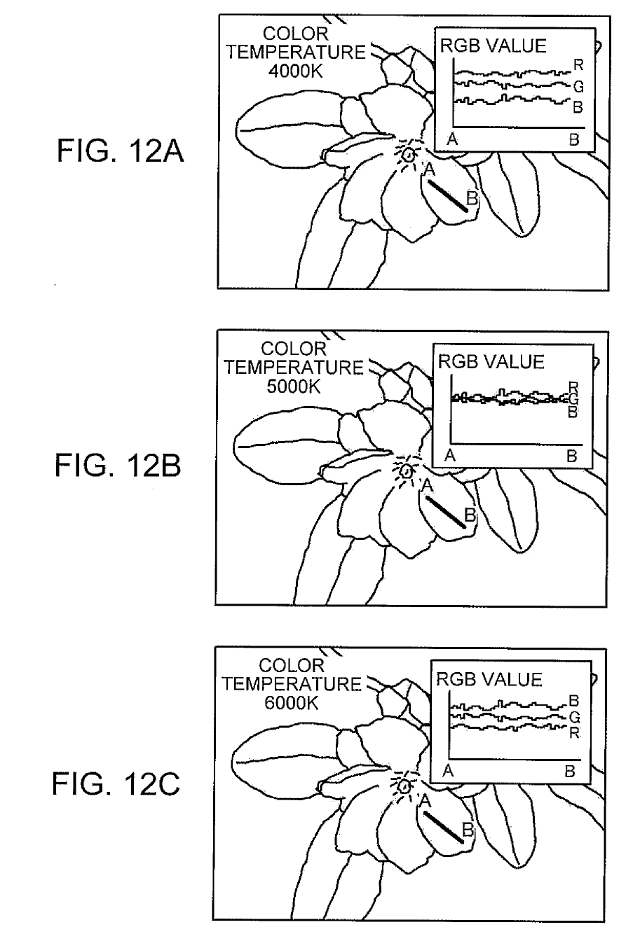

Further, it is also possible to check whether or not the white balance adjustment is appropriate besides the correction process. FIGS. 12A through 12C are explanatory diagrams showing the condition in which the change in the tone value in the image data is checked while the white balance is being adjusted. Here, the white balance adjustment denotes the following operation. That is, as described above, the digital camera 100 generates the image data by combining the light intensity signals corresponding respectively to red, green, and blue detected by the optical sensor 24, and on this occasion, the color shade of the image data thus generated varies depending on the proportions of the light intensity signals of the respective colors to be combined. Therefore, the operation for adjusting the proportions of the respective colors so that the color shade perceived by the human when the human viewing the object can be reproduced by the image is denoted as the white balance adjustment. Generally, the white balance adjustment is performed so that the object, which looks white when the human actually views the object, also looks white on the image. Since white looks tinted when the image is viewed on the monitor screen 34 under the influence of the condition of the color adjustment of the monitor screen 34, the condition of the environmental light in the place where the monitor screen is viewed, and so on, it is difficult to perform the appropriate white balance adjustment on the monitor screen 34. Therefore, as shown in FIGS. 12A through 12C, when the graph of the tone values of RGB of the image data is displayed while the white balance is being adjusted, it becomes possible to perform the appropriate white balance adjustment that makes each of the tone values of RGB substantially the same (namely white) It is obvious that on this occasion, since the part where the RGB tone values are examined can freely be selected, it is possible for the shooter to select the object, which looked white to the shooter when the image was shot. Thus, it becomes possible to perform the white balance adjustment so that the impression received from the object when the shooter actually viewed the object and the impression received from the image become more identical to each other, as a result, it becomes possible for the shooter to obtain the image data having the appropriate color shade.

Although the image display device of the present embodiment is explained hereinabove, the invention is not limited to the entire embodiment described above, but can be put into practice in various forms within the scope or spirit of the invention. For example, although in the embodiment the explanations are presented exemplifying the image display device mounted on the digital camera, the invention can be put into practice in the forms such as an image display device mounted on a camera cell-phone, dedicated equipment for displaying an image such as a photo viewer, an image display device mounted on an unattended photo printing terminal placed on a street corner, a public area, or the like.

The entire disclosure of Japanese Patent Application No. 2007-207510, filed Aug. 9, 2007 is expressly incorporated by reference herein.

What is claimed is:

1. An image display device used for checking an image represented by digital image data, comprising:
a display section that displays the image and checking information used for checking the image;
an image display control section that displays the image on the display section based on the digital image data;
a checking line segment designation section that allows designation of a checking line segment, which is a series of checking places in the image, on the display section on which the image is displayed; and
a checking information display control section that displays a changing condition of the digital image data along the checking line segment on the display section as the checking information.

2. The image display device according to claim 1,
wherein the checking line segment designation section is a section that allows designation of the checking line segment by allowing designation of a plurality of places on the display section on which the image is displayed.

3. The image display device according to claim 1,
wherein the checking line segment designation section is a section that allows designation of the checking line segment by allowing selection of the checking line segment from a plurality of candidates of the checking line segment set previously.

4. The image display device according to claim 1,
wherein the checking information is a changing condition of a luminance on the checking line segment calculated based on the digital image data.

5. The image display device according to claim 1,
wherein the checking information is a changing condition of a tone value of each component forming the digital image data.

6. The image display device according to claim 1, further comprising:
a correction section that corrects the digital image data,
wherein the checking information display control section, in response to the digital image data being corrected, displays a changing condition of the corrected digital image data on the display section as the checking information.

7. An image display method used for checking an image represented by digital image data using an image display device having a display section that displays the image and checking information used for checking the image, the method, comprising:
displaying the image on a display section based on a digital image data;
allowing designation of a checking line segment, which is a series of checking places in the image, on the display section on which the image is displayed; and
displaying a changing condition of the digital image data along the checking line segment on the display section as checking information used for checking the image.

8. An image display computer-readable medium for allowing a computer execute a process used for checking the image, having a display section that displays an image represented by digital image data and checking information used for checking the image to the process comprising:
displaying the image on a display section based on a digital image data;
allowing designation of a checking line segment, which is a series of checking places in the image, on the display section on which the image is displayed; and
displaying a changing condition of the digital image data along the checking line segment on the display section as checking information used for checking the image.
